(19) United States
(12) Patent Application Publication
(10) Pub. No.: US 2024/0040520 A1
(43) Pub. Date: Feb. 1, 2024

(54) TERMINAL, RADIO COMMUNICATION METHOD, AND BASE STATION

(71) Applicant: NTT DOCOMO, INC., Tokyo (JP)

(72) Inventors: Yuki Matsumura, Tokyo (JP); Satoshi Nagata, Tokyo (JP); Jing Wang, Beijing (CN); Lan Chen, Beijing (CN)

(73) Assignee: NTT DOCOMO, INC., Tokyo (JP)

(21) Appl. No.: 18/256,297

(22) PCT Filed: Dec. 11, 2020
(86) PCT No.: PCT/JP2020/046319

§ 371 Date: Jun. 7, 2023

(51) Int. Cl. H04W 52/36; H04W 72/231

(52) U.S. Cl. CPC H04W 52/367; H04W 72/231

(57) ABSTRACT

A terminal according to one aspect of the present disclosure includes a receiving section that receives a higher layer parameter corresponding to a report related to maximum permitted exposure (MPE) specific to a beam, and a control section that controls transmission of the report using a medium access control (MAC) control element (CE), based on the higher layer parameter. According to one aspect of the present disclosure, the report related to MPE can be appropriately performed.

### TECHNICAL FIELD

The present disclosure relates to a terminal, a radio communication method, and a base station in next-generation mobile communication systems.

### BACKGROUND ART

In a Universal Mobile Telecommunications System (UMTS) network, the specifications of Long-Term Evolution (LTE) have been drafted for the purpose of further increasing high speed data rates, providing lower latency and so on (see Non-Patent Literature 1). In addition, for the purpose of further high capacity, advancement and the like of the LTE (Third Generation Partnership Project (3GPP) Release (Rel.) 8 and Rel. 9), the specifications of LTE-Advanced (3GPP Rel. 10 to Rel. 14) have been drafted.

Successor systems of LTE (for example, also referred to as “5th generation mobile communication system (5G),” “5G+ (plus),” “6th generation mobile communication system (6G),” “New Radio (NR),” “3GPP Rel. 15 (or later versions),” and so on) are also under study.

In existing LTE systems (for example, 3GPP Rel. 8 to Rel. 14), a user terminal (User Equipment (UE)) transmits uplink control information (UCI) by using at least one of a UL data channel (for example, a Physical Uplink Shared Channel (PUSCH)) and a UL control channel (for example, a Physical Uplink Control Channel (PUCCH)).

### CITATION LIST

### Non-Patent Literature

Non-Patent Literature 1: 3GPP TS 36.300 V8.12.0 “Evolved Universal Terrestrial Radio Access (E-UTRA) and Evolved Universal Terrestrial Radio Access Network (E-UTRAN); Overall description; Stage 2 (Release 8),” April, 2010

### SUMMARY OF INVENTION

### Technical Problem

For NR, countermeasures against a problem of maximum permissible exposure (maximum permitted exposure (MPE)) have been under study. The UE is required to satisfy regulations of Federal Communication Commission (FCC) related to maximum radiation to human bodies for the sake of health and safety.

In order to address the MPE problem, it is considered that a report related to MPE of a UL transmit beam is performed. However, when the UE uses a plurality of transmit beams, how to perform the report related to MPE has not been studied yet. Unless the report related to MPE is appropriately performed, system performance such as throughput may be reduced.

In view of this, the present disclosure has one object to provide a terminal, a radio communication method, and a base station, with which the report related to MPE can be appropriately performed.

### Solution to Problem

A terminal according to one aspect of the present disclosure includes a receiving section that receives a higher layer parameter corresponding to a report related to maximum permitted exposure (MPE) specific to a beam, and a control section that controls transmission of the report using a medium access control (MAC) control element (CE), based on the higher layer parameter.

### Advantageous Effects of Invention

According to one aspect of the present disclosure, the report related to MPE can be appropriately performed.

### BRIEF DESCRIPTION OF DRAWINGS

FIG. 1 is a diagram to show an example of a single entry PHR MAC CE in Rel. 16.

FIG. 2 is a diagram to show a first example of a multi-entry PHR MAC CE in Rel. 16.

FIG. 3 is a diagram to show a second example of a multi-entry PHR MAC CE in Rel. 16.

FIG. 4 is a diagram to show an example of a PHR MAC CE used in a beam specific MPE report.

FIG. 5 is a diagram to show an example of a schematic structure of a radio communication system according to one embodiment.

FIG. 6 is a diagram to show an example of a structure of a base station according to one embodiment.

FIG. 7 is a diagram to show an example of a structure of a user terminal according to one embodiment.

FIG. 8 is a diagram to show an example of a hardware structure of the base station and the user terminal according to one embodiment.

### DESCRIPTION OF EMBODIMENTS

### (MPE)

For NR, countermeasures against a problem of maximum permitted exposure (MPE) (or electromagnetic power density exposure) have been under study. The UE is required to satisfy regulations of Federal Communication Commission (FCC) related to maximum radiation to human bodies for the sake of health and safety. For example, in Rel-15 NR, the following two limitation methods are defined as regulations for limiting exposure (explosure).

### <Limitation Method 1>

As limitation method 1, limitation using power management maximum power reduction (P-MPR, maximum permitted UE output power reduction) is defined. For example, the UE maximum output power P_{CMAX,f,c} is configured so that corresponding P_{UMAX,f,c} (measured maximum output power, measured maximum configured UE output power) satisfies the following expression (1).

P_{Powerclass}−MAX(MAX(MPR_{f,c},A-MPR_{f,c})+ΔMB_{P,n},P-MPR_{f,c})−MAX{T(MAX(MPR_{f,c},A-MPR_{f,c})),T(P-MPR_{f,}c)}≤P_{UMAX,f,c}≤EIRPₘₐₓ (1)

EIRPₘₐₓ is a maximum value of corresponding measurement peak equivalent isotopically radiated power (EIRP). P-MPR_{f,c} is a value indicating reduction of maximum output power permitted for a carrier f of a serving cell c. P-MPR_{f,c} is introduced into the expression of the UE maximum output power P_{CMAX,f,c} configured for the carrier f of the serving cell c. With this, the UE can report its available maximum output transmission power to a base station (for example, a gNB). The report can be used by the base station for determination of scheduling. P-MPR_{f,c} may be used for ensuring compliance with available electromagnetic energy absorption requirements and addressing unnecessary radiation/self-defense requirements in a case of simultaneous transmission in a plurality of RATS for a scenario not within a scope of use of 3GPP RAN, or may be used for ensuring compliance with available electromagnetic energy absorption requirements in a case where proximity detection is used for addressing such requirements that require lower maximum output power.

### <Limitation Method 2>

In 3GPP Rel-15 NR, in order to satisfy guidelines of protection of human bodies against millimeter waves, UE capability information of reporting an uplink transmission rate at which the UE can perform transmission without requiring application of P-MPR has been introduced. The capability information may be referred to as a maximum uplink duty cycle (maxUplinkDutyCycle-FR2) in Frequency Range 2 (FR2).

maxUplinkDutyCycle-FR2 corresponds to a higher layer parameter. maxUplinkDutyCycle-FR2 may be an upper limit of a UL transmission ratio within a certain evaluation period (for example, one second). In Rel-15 NR, the value is one of n15, n20, n25, n30, n40, n50, n60, n70, n80, n90, and n100, which correspond to 15%, 20%, 25%, 30%, 40%, 50%, 60%, 70%, 80%, 90%, and 100%, respectively. maxUplinkDutyCycle-FR2 may be applied to all of the UE power classes in FR2. Note that a default value need not be defined for maxUplinkDutyCycle-FR2.

When a field of maxUplinkDutyCycle-FR2 is present as the UE capability information, and the ratio of UL (Uplink) symbols transmitted within an evaluation period of one second is higher than maxUplinkDutyCycle-FR2, the UE may apply the limitation (limitation method 1) using P-MPR in accordance with UL scheduling. Otherwise, the UE need not apply P-MPR.

When the field of maxUplinkDutyCycle-FR2 is not present as the UE capability information, conformity with electromagnetic power density exposure requirements (MPE requirements) may be ensured, using reduction of power density or another means.

### <MPE Report>

In order to achieve high-speed selection of a UL panel, prompting UL transmit beam selection for the UE including a plurality of panels (multi-panel) based on a UL beam indication has been under study, with UL coverage loss due to MPE being taken into consideration.

However, how to increase the speed of selection of a beam/panel based on MPE and how to notify an NW of the selection in order to avoid blind detection of the network pose problems. Unless selection of a beam/panel based on MPE is performed at high speed, this may lead to reduction of system performance, such as reduction of throughput. When the UE voluntarily changes a UL transmit beam and the network is not notified of the changed UL transmit beam, the network performs blind detection to determine a UL receive beam. This may lead to reduction of system performance, such as reduction of throughput.

In view of this, it is considered that the UE reports a fact that an uplink transmit beam does not satisfy the maximum permitted exposure (MPE) (MPE) requirements.

When the UE is configured with a report triggered by the UE (for example, with RRC layer signaling) for the MPE problem, and the UE detects the MPE problem for the indicated UL beam, the UE may report occurrence of the MPE problem.

In the present disclosure, an MPE event, an MPE problem, an MPE failure, a fact that the MPE requirements are not satisfied, and a fact that the MPE requirements cannot be passed may be interchangeably interpreted as each other. In the present disclosure, MPE safe, MPE adapted, no occurrence of the MPE problem, no occurrence of the MPE failure, a fact that the MPE requirements are satisfied, and a fact that the MPE requirements can be passed may be interchangeably interpreted as each other. In the present disclosure, a report of occurrence of the MPE problem, a report of the MPE problem, a first report, and a request to solve the MPE problem may be interchangeably interpreted as each other.

When a UL transmit beam or a reference signal (RS) indicated for UL transmission (for example, a PUSCH) does not satisfy the MPE requirements (when a power parameter for the indicated UL transmit beam does not satisfy the MPE requirements), the UE may detect (determine) the MPE problem. The indication of the UL transmit beam may be an SRS resource indicator (SRI) for indicating sounding reference signal (SRS) resources for the PUSCH, or may be spatial relation information, a transmission configuration indicator (TCI) state, or a quasi co-location (QCL)) assumption for at least one of the PUCCH, the PUSCH, the SRS, and the PRACH.

The MPE requirements may be satisfaction of at least one of the following.
P-MPR_{f,c} required in consideration of MPE is larger than a P-MPR threshold.
P_{CMAX,f,c} calculated in consideration of MPE (maximum output power configured for the UE for the carrier f of the serving cell c) is smaller than a P_{CMAX} threshold.
A Power Headroom (PH) value (for example, actual PH, virtual PH) calculated in consideration of MPE is smaller than a PH threshold.

At least one of the P-MPR threshold, the P_{CMAX} threshold, and the PH threshold may be defined in advance, or may be configured.

In response to detection of the MPE problem, the UE may report an MPE problem occurrence.

In response to detection of the MPE problem occurrence, the UE may determine a UL transmit beam/panel satisfying the MPE requirements and report the UL transmit beam/panel. In the present disclosure, a UL transmit beam/panel satisfying the MPE requirements, an MPE adapted beam/panel, an MPE safe beam/panel, a candidate beam/panel, and a new UL transmit beam/panel may be interchangeably interpreted as each other. In the present disclosure, an MPE adapted beam/panel report, an MPE adapted beam/panel list, and a UL transmit beam/panel change plan may be interchangeably interpreted as each other.

The UE may report at least one determined MPE adapted beam/panel, and manage the UL beam.

### <New MAC CE>

A new medium access control control element (MAC CE) including a new logical channel ID (LCID) for a report of at least one of the MPE problem occurrence and information related to a beam/panel (MPE adapted beam/panel) satisfying the MPE requirements for one or more cells and BWPs may be defined. The new MAC CE may indicate at least one of a new UL transmit beam/panel and a cell in which the MPE problem has occurred. The new MAC CE may include at least one of the following contents 1 to 8.

### [Content 1]

A field of 0 or 1 bit for indicating the MPE problem for each cell/BWP. The MAC CE may include a field for one or more cells/BWPs. The MAC CE may include cell/BWP index(es).

### [Content 2]

Index(es) of one or more or up to N MPE adapted beams/panels for one cell/BWP in which the MPE problem is detected.

### [Content 3]

Index(es) of the MPE adapted beam(s)/panel(s) for a plurality of cells/BWPs in which the MPE problem is detected. The MAC CE may include index(es) of one or more or up to N MPE adapted beams/panels for each of the plurality of cells/BWPs.

### [Content 4]

P-MPR required for the index of each beam/panel, in addition to at least one of contents 1, 2, and 3.

### [Content 5]

Remaining power estimated in consideration of P-MPR (remaining power estimated in consideration of MPE) for the index of each beam/panel, in addition to at least one of contents 1, 2, and 3. The estimated remaining power may be a PH value based on an actual transmission or a reference format (a virtual transmission) in consideration of MPE, or may be Power Headroom Reporting (PHR) in consideration of MPE for each beam. The PHR may include contents in a PHR MAC CE (at least one of a PH type, a PH value, and P_{CMAX,f,c})

### [Content 6]

P_{CMAX,f,c} calculated for the index of each beam/panel, in addition to at least one of contents 1, 2, and 3.

### [Content 7]

A combination of two out of contents 1 to 6.

### [Content 8]

A field (bit) indicating that the MPE adapted beam/panel cannot be found for the cell/BWP, based on content 7.

The index of the beam/panel may be an index of an SSB/CSI-RS/SRS, or the index of the beam/panel may be configured together with the index of the SSB/CSI-RS/SRS. A panel index may be an index of an RS group/RS set, an index of an antenna port/antenna port group/antenna port set, an index of an antenna assumption/antenna mode, or another new index.

### <PHR MAC CE>

In 3GPP Rel. 16, as RRC parameters for controlling the PHR, mpe-Reporting, mpe-ProhibitTimer, and mpe-Threshold are defined. mpe-Reporting indicates whether the UE reports MPE P-MPR in the PHR MAC CE. mpe-ProhibitTimer is a timer started when an MPE P-MPR report is triggered, and indicates the number of subframes. mpe-Threshold indicates a P-MPR threshold [dB] for the MPE P-MPR report when FR2 is configured.

When mpe-Reporting is configured, mpe-ProhibitTimer is not executed, and P-MPR applied and measured for satisfying the MPE requirements in at least one activated serving at or after the last transmission of the PHR in a MAC entity is equal to or larger than mpe-Threshold, the PHR is triggered.

When mpe-Reporting is configured, mpe-ProhibitTimer is not executed, and P-MPR applied and measured for satisfying the MPE requirements in at least one activated serving is equal to or larger than mpe-Threshold, the MPE P-MPR report is triggered.

When mpe-Reporting is configured, the UE acquires a P-MPR value corresponding to an MPE field from a physical layer, and sets a corresponding P field in the PHR MAC CE in accordance with the acquired P-MPR value. The PHR MAC CE may be either a multi-entry PHR MAC CE (multi-PHR) or a single entry PHR MAC CE (single PHR).

When the MPE P-MPR report is triggered, the UE starts or resumes mpe-ProhibitTimer, and cancels the MPE P-MPR report included in the PHR MAC CE and triggered for the serving cell.

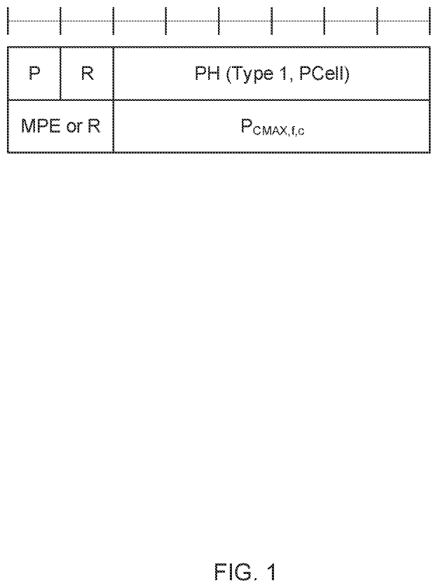

FIG. 1 is a diagram to show an example of the single entry PHR MAC CE in Rel. 16. When mpe-Reporting is configured, the “P” field indicates power back-off applied for satisfying the MPE requirements, whereas when mpe-Reporting is not configured, the “P” field indicates whether the MAC entity (UE) applies power back-off by power management. The “P_{CMAX,f,c}” field indicates P_{CMAX,f,c} used for calculation of a preceding PH field. “R” indicates a reserved bit. The “PH” field indicates a power headroom level. The “P” field indicates power back-off applied for satisfying the MPE requirements, when mpe-Reporting is configured. The “MPE” field indicates power back-off applied for satisfying the MPE requirements, when mpe-Reporting is configured and 1 is set to the “P” field. The “MPE” field serves as a reserved bit (R), when mpe-Reporting is not configured, or 0 is set to the “P” field.

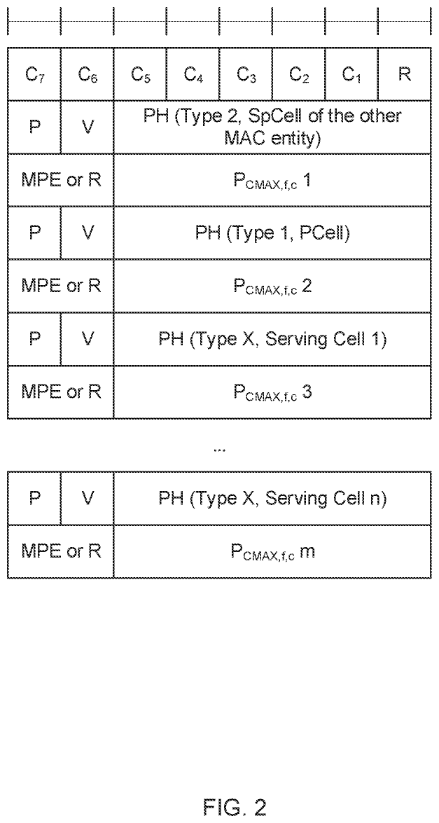

FIG. 2 is a diagram to show a first example of the multi-entry PHR MAC CE in Rel. 16. The example of FIG. 2 is applied when the largest serving cell index in the serving cell configured in the uplink is less than 8.

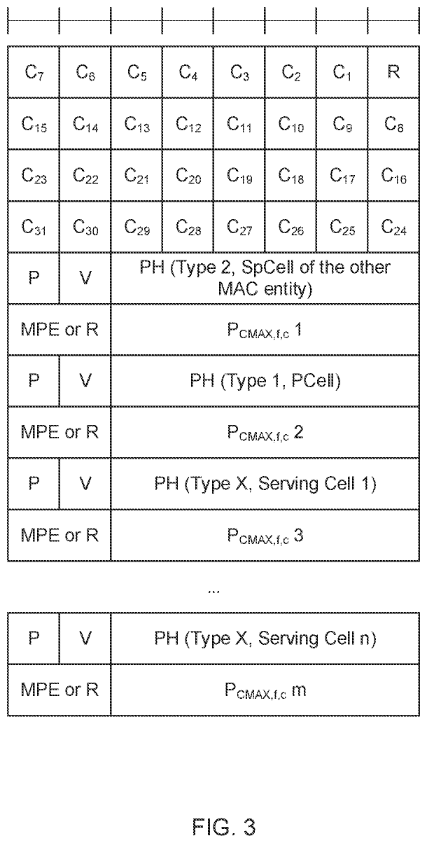

FIG. 3 is a diagram to show a second example of the multi-entry PHR MAC CE in Rel. 16. The example of FIG. 3 is applied when the largest serving cell index in the serving cell configured in the uplink is equal to or larger than 8.

The “Cᵢ” field in FIG. 2 and FIG. 3 indicates presence of the “PH” field in the serving cell having a serving cell index i. The “V” field indicates whether the PH value is based on an actual transmission or is based on a reference format. In the example of FIG. 2 and FIG. 3, each field (“P”, “R”, “PH”, “P_{CMAX,f,c}”, and “MPE”) shown in FIG. 1 is set for each serving cell.

As described above, in order to address the MPE problem, it is considered that the UE transmits a report related to MPE of a UL transmit beam. However, when the UE uses a plurality of transmit beams/panels, how to perform the report related to MPE has not been studied yet. Unless the report related to MPE is appropriately performed, system performance such as throughput may be reduced.

In view of this, the inventors of the present invention came up with the idea of a terminal that can appropriately perform the report related to MPE when the UE uses a plurality of transmit beams/panels.

Embodiments according to the present disclosure will be described in detail with reference to the drawings as follows. The radio communication methods according to respective embodiments may each be employed individually, or may be employed in combination.

In the present disclosure, “A/B/C” and “at least one of A, B, and C” may be interchangeably interpreted as each other. In the present disclosure, a cell, a CC, a carrier, a BWP, a DL BWP, a UL BWP, an active DL BWP, an active UL BWP, and a band may be interchangeably interpreted as each other. In the present disclosure, an index, an ID, an indicator, and a resource ID may be interchangeably interpreted as each other. In the present disclosure, to support, to control, to be able to control, to operate, and to be able to operate may be interchangeably interpreted as each other.

In the present disclosure, configure, activate, update, indicate, enable, specify, and select may be interchangeably interpreted as each other.

In the present disclosure, a MAC CE and an activation/deactivation command may be interchangeably interpreted as each other.

In the present disclosure, higher layer signaling may be, for example, any one of Radio Resource Control (RRC) signaling, Medium Access Control (MAC) signaling, broadcast information, and the like, or a combination of these. In the present disclosure, RRC, RRC signaling, an RRC parameter, a higher layer, a higher layer parameter, an RRC information element (IE), and an RRC message may be interchangeably interpreted as each other.

As the MAC signaling, for example, a MAC control element (MAC CE), a MAC Protocol Data Unit (PDU), or the like may be used. The broadcast information may be, for example, a master information block (MIB), a system information block (SIB), minimum system information (Remaining Minimum System Information (RMSI)), other system information (OSI), or the like.

In the present disclosure, a beam, a panel, a spatial domain filter, a space setting, a TCI state, a TCI state pool, a plurality of TCI states, a UL TCI state, a unified TCI state, a unified beam, a common TCI state, a common beam, a QCL assumption, a QCL parameter, a spatial domain reception filter, a UE spatial domain reception filter, a UE receive beam, a DL beam, a DL receive beam, DL precoding, a DL precoder, a DL-RS, an RS of QCL type D of the TCI state/QCL assumption, an RS of QCL type A of the TCI state/QCL assumption, a spatial relation, a spatial domain transmission filter, a UE spatial domain transmission filter, a UE transmit beam, a UL beam, a UL transmit beam, UL precoding, a UL precoder, and a PL-RS may be interchangeably interpreted as each other. In the present disclosure, a QCL type X-RS, a DL-RS associated with QCL type X, a DL-RS including QCL type X, a source of the DL-RS, an SSB, a CSI-RS, and an SRS may be interchangeably interpreted as each other.

### (Radio Communication Method)

The UE receives higher layer parameter(s) (RRC parameter(s)) corresponding to a report (MPE report) related to maximum permitted exposure (MPE) (MPE) specific to a beam (beam specific), and controls transmission of the report using the MAC CE (PHR MAC CE), based on the higher layer parameter(s). As the terms for the RRC parameters corresponding to the beam specific MPE report, “new-mpe-Reporting”, “new-mpe-ProhibitTimer”, and “new-mpe-Threshold” are hereinafter used. However, other terms may be used.

In the present disclosure, a beam, a panel, and a beam and a panel may be interchangeably interpreted as each other. In the present disclosure, MPE, MPE P-MPR, and P-MPR may be interchangeably interpreted as each other.

### First Embodiment

The RRC parameter new-mpe-Reporting indicating whether to transmit the beam specific MPE report may be defined. When new-mpe-Reporting is configured, the UE performs beam specific P-MPR measurement for satisfying the MPE requirements, and triggers the beam specific MPE report.

As the RRC parameter corresponding to the beam specific MPE report, new-mpe-ProhibitTimer being a timer executed when the MPE report is triggered may be configured. A plurality of new-mpe-ProhibitTimers may be configured, and each of the plurality of new-mpe-ProhibitTimers may be related to a beam. When the MPE report is triggered for a certain beam, new-mpe-ProhibitTimer related to a corresponding beam of the UE may be started or resumed, and a triggered MPE P-MPR report for a beam of the serving cell included in the PHR MAC CE or a new MPE MAC CE may be cancelled. The new MPE MAC CE may be, for example, a MAC CE illustrated in a third embodiment to be described later.

As the RRC parameter corresponding to the beam specific MPE report, new-mpe-Threshold being a threshold corresponding to power management maximum power reduction (P-MPR) for a beam may be configured, and may be applied to all of the configured beams.

A plurality of new-mpe-Thresholds may be configured, and each of the plurality of new-mpe-Thresholds may be related to a beam. The UE may compare beam specific P-MPR measured for satisfying the MPE requirements and its corresponding (related) new-mpe-Threshold.

For example, when new-mpe-Reporting is configured, new-mpe-ProhibitTimer is not executed, and P-MPR for the beam applied and measured for satisfying the MPE requirements in at least one activated serving at or after the last transmission of the PHR in a MAC entity is equal to or larger than new-mpe-Threshold of a corresponding beam, the PHR may be triggered.

### Second Embodiment

A configuration aspect of beam specific RRC parameter(s) and a relationship between a UE specific MPE report and the beam specific MPE report will be described. For example, the beam specific RRC parameter may be configured for each UE (terminal), for each cell group, for each serving cell, or for each bandwidth part (BWP). The beam specific RRC parameter in each aspect of the present embodiment may be at least one of new-mpe-Reporting, new-mpe-ProhibitTimer, and new-mpe-Threshold described in the first embodiment.

In the present disclosure, the RRC parameter (an RRC parameter corresponding to the MPE report), the MPE report, the P-MPR report, and the MPE P-MPR report may be interchangeably interpreted as each other.

### [Aspect 2-1]

The beam specific RRC parameter may be configured for each UE, and applied to all of FR2 serving cells.

### [Aspect 2-2]

The beam specific RRC parameter may be configured for each cell group (Master cell group (MCG)/Secondary cell group (SCG)/PUCCH cell group) of the UE, and applied to all of serving cells in the configured cell group.

### [Aspect 2-3]

The beam specific RRC parameter may be configured for each serving cell of the UE, and different parameters may be configured for different serving cells.

### [Aspect 2-4]

The beam specific RRC parameter may be configured for each BWP in the serving cell of the UE, and different parameters may be configured for different BWPs.

Regarding the relationship between the UE specific MPE report and the beam specific MPE report, examples of the following aspects A to D will be described. One of aspects A to D may be combined with one of aspects 2-1 to 2-4. The RRC parameter corresponding to the UE specific MPE report may be at least one of mpe-Reporting, mpe-ProhibitTimer, and mpe-Threshold of 3GPP Rel. 16 described above. The UE specific MPE report may be, for example, a report on the MAC CE shown in FIG. 1 to FIG. 3.

### [Aspect A]

The UE may be configured with one of the UE specific MPE report and the beam specific MPE report. When the beam specific MPE report is configured, the UE need not assume that the UE specific MPE report is configured. When the UE specific MPE report is configured, the UE need not assume that the beam specific MPE report is configured.

When aspect 2-1 is applied, the UE may be configured with one of the UE specific MPE report and the beam specific MPE report, and transmit one of the reports. When aspect 2-2 is applied, the same MPE report (UE specific or beam specific) may be configured for different cell groups. When aspect 2-3 is applied, the same MPE report (UE specific or beam specific) may be configured for different cells (serving cells). When aspect 2-4 is applied, the same MPE report (UE specific or beam specific) may be configured for different BWPs in the serving cell.

### [Aspect B]

The UE may be configured with both of the UE specific MPE report and the beam specific MPE report, and transmit both of the reports. The UE may be configured with different MPE reports for different cells/cell groups/BWPs. When aspect 2-2 is applied, different MPE reports (UE specific or beam specific) may be configured for different cell groups. When aspect 2-3 is applied, different MPE reports (UE specific or beam specific) may be configured for different cells (serving cells). When aspect 2-4 is applied, different MPE reports (UE specific or beam specific) may be configured for different BWPs.

### [Aspect C]

The UE may be configured with both of the UE specific MPE report and the beam specific MPE report, and transmit both of the reports. The UE may be configured with the same MPE report for different cells/cell groups/BWPs. When the PHR or the P-MPR report is triggered, the UE may determine (select) at least one of the UE specific MPE report and the beam specific MPE report, based on implementation of the UE or a certain rule (specification). When the UE is configured with both of the UE specific MPE report and the beam specific MPE report, the UE may apply the beam specific MPE report.

### [Aspect D]

In aspect A/B/C, regarding which is applied by the UE among the UE specific MPE report and the beam specific MPE report, further condition(s) based on an additional configuration may be used.

When at least one of the following conditions of (1) and (2) is satisfied, the UE may transmit the UE specific MPE report by using the MAC CE.

(1) The PHR has been triggered.
(2) The beam specific MPE report is not triggered.

Only when the beam specific MPE report is triggered, the UE may transmit the beam specific MPE report by using the MAC CE.

In the beam specific MPE report, when a plurality of (all of) beams are triggered, the UE specific MPE report may be included in the MAC CE.

### [Trigger Conditions]

With a metric or a threshold (mpe-Threshold/new-mpe-Threshold) for detection of the MPE problem being different, in a case where trigger conditions (conditions of detecting the MPE problem) of the UE specific MPE report (mpe-Reporting) and the beam specific MPE report (new-mpe-Reporting) are different, the UE may follow the following procedures.

When one of the RRC parameters mpe-Reporting and new-mpe-Reporting is configured (detected), the UE initiates corresponding MPE procedure #1, and subsequently, when the other parameter (corresponding to other MPE procedure #2) out of mpe-Reporting and new-mpe-Reporting is configured (detected), the UE performs one of the following processing of (1) to (4). MPE procedures #1 and #2 are, for example, a UE specific MPE report (mpe-Reporting) procedure or a beam specific MPE report (new-mpe-Reporting) procedure.

(1) The UE continues MPE procedure #1 that has already been initiated, and ignores other MPE procedure #2.
(2) The UE ends MPE procedure #1 that has already been initiated, and initiates other MPE procedure #2.
(3) The UE may determine whether to continue or end MPE procedure #1 that has already been initiated, based on whether MPE procedure #1 that has already been initiated is new-mpe-Reporting or mpe-Reporting. For example, when MPE procedure #1 that has already been initiated is new-mpe-Reporting, the UE may continue MPE procedure #1. When MPE procedure #1 that has already been initiated is mpe-Reporting, the UE may end MPE procedure #1.
(4) The UE may determine whether to continue or end MPE procedure #1 that has already been initiated, based on whether MPE procedure #2 corresponding to another detected MPE problem is new-mpe-Reporting or mpe-Reporting. For example, when MPE procedure #2 is new-mpe-Reporting, the UE may end MPE procedure #1. When MPE procedure #2 is mpe-Reporting, the UE may continue MPE procedure #1.

Note that the trigger conditions of mpe-Reporting and new-mpe-Reporting may be the same. In this case, the UE may select one of mpe-Reporting and new-mpe-Reporting, based on a certain rule (specification). For example, the trigger condition of the UE specific MPE report is a condition that P-MPR measured for satisfying the MPE requirements is equal to or larger than mpe-Threshold. The trigger condition of a panel specific MPE report is a condition that P-MPR for the panel measured for satisfying the MPE requirements is larger than new-mpe-Threshold. Thus, when simultaneous transmission from a plurality of panels is not performed, and mpe-Threshold and new-mpe-Threshold are the same, the trigger conditions of mpe-Reporting and new-mpe-Reporting are the same.

### Third Embodiment

For the beam specific MPE report, the same set of octets (each being a field of 8 bits) as that of the single entry or multi-entry PHR MAC CE in Rel. 16 shown in FIG. 1 to FIG. 3 may be used. For example, each set (entry) of the PHR MAC CE may correspond to the beam/panel in the serving cell.

### [Aspect 3-1]

When the beam specific MPE report is triggered for the serving cell, pieces of information of all of the beams of the serving cell may be reported in specific order. The size of the MAC CE may be related to the serving cell/cell group/FR/maximum number of panels in the UE (maximum number of UL panels). In this case, beam IDs/panel IDs are determined based on the order of entries in the MAC CE, and thus the UE need not report the beam IDs/panel IDs.

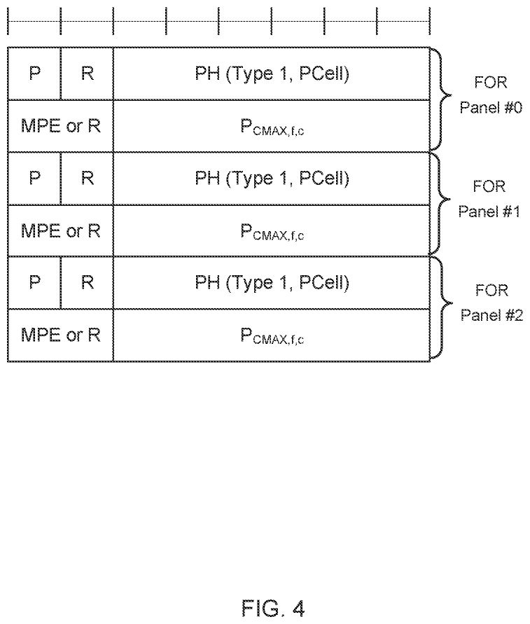

FIG. 4 is a diagram to show an example of the PHR MAC CE used in the beam specific MPE report. In the example of FIG. 4, the PHR MAC CE includes the MPE report for panels #0 to #2. In other words, the MPE report for a maximum of three panels can be performed. Two octets are used for one panel. Panels #0 to #2 may be interchangeably used for beams #0 to #2.

### [Aspect 3-2]

When the beam specific MPE P-MPR report is triggered for the serving cell, only one piece of beam/panel information may be reported, or the MPE report for a plurality of (a part of) beams/panels may be performed based on a condition determined in a specification. In this case, the size of the MAC CE is variable.

The beam ID/panel ID/size of the MAC CE may be added to the MAC CE. As a field for the beam ID/panel ID/size of the MAC CE, at least one of the P field and the R field or at least one value indicated by at least one of the P field and the R field may be reused, or a new field may be added. With the beam IDs/panel IDs being included, even when a plurality of (a part of) beams/panels are reported, the beams/panels can be identified. With the size of the MAC CE being included, even when the size of the MAC CE is variable, the size can be identified. Note that, in aspect 3-2, only the beams/panels to which power back-off is applied are reported on the MAC CE, and thus power back-off need not be indicated again in the P field. Whether an existing field is reused or a new field is added may be determined according to a maximum number of panels of the UE. The UE may determine the beams/panels to be reported, based on the following condition 1 or condition 2.

### [[Condition 1]]

When P-MPR for a beam applied and measured for satisfying the MPE requirements is equal to or larger than new-mpe-Threshold of a corresponding beam, the MPE report of only the beam may be transmitted.

### [[Condition 2]]

Together with one or a plurality of beams corresponding to P-MPR of equal to or larger than new-mpe-Threshold, the UE may report at least one MPE safe beam (if any). The MPE safe beam is, for example, one or a plurality of beams corresponding to P-MPR of less than new-mpe-Threshold.

The number of sets of octets of the PHR MAC CE in different serving cells may be the same or different. For example, when a certain serving cell is configured with UE specific MPE, and another serving cell is configured with panel specific MPE, the number of sets of octets of the PHR MAC CE used for the MPE report in the respective serving cells may be different. When the maximum numbers of panels of the respective serving cells are different, or the respective serving cells report influence of different number of panels, the number of sets of octets of the PHR MAC CE used for the MPE report may be different.

### <UE Capability>

The UE may transmit (report) a UE capability indicating whether to support the beam specific MPE report for each UE/for each cell group/for each serving cell. The UE may transmit (report) a UE capability indicating whether to support beam specific new-mpe-ProhibitTimer for each UE/for each cell group/for each serving cell. The UE may transmit (report) a UE capability indicating whether to support beam specific new-mpe-Threshold for each UE/for each cell group/for each serving cell.

The UE may transmit (report) a UE capability indicating whether both of the UE specific MPE report and the beam specific are configured for the same cell/cell group (or different cells/cell groups). The UE may transmit (report) a UE capability indicating whether to transmit the beam specific MPE report regarding all of the beams. The UE may transmit (report) a UE capability indicating whether to report the beam IDs/panel IDs in the MAC CE for the beam specific MPE report.

### (Radio Communication System)

Hereinafter, a structure of a radio communication system according to one embodiment of the present disclosure will be described. In this radio communication system, the radio communication method according to each embodiment of the present disclosure described above may be used alone or may be used in combination for communication.

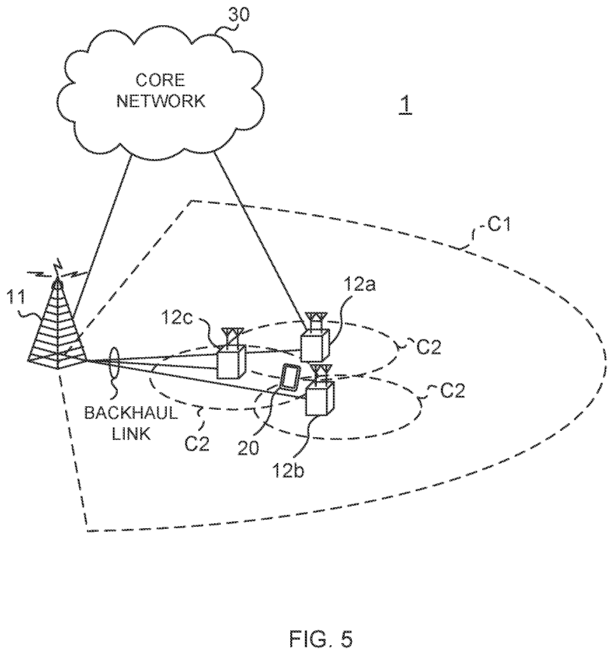

FIG. 5 is a diagram to show an example of a schematic structure of the radio communication system according to one embodiment. The radio communication system 1 may be a system implementing a communication using Long Term Evolution (LTE), 5th generation mobile communication system New Radio (5G NR) and so on the specifications of which have been drafted by Third Generation Partnership Project (3GPP).

The radio communication system 1 may support dual connectivity (multi-RAT dual connectivity (MR-DC)) between a plurality of Radio Access Technologies (RATs). The MR-DC may include dual connectivity (E-UTRA-NR Dual Connectivity (EN-DC)) between LTE (Evolved Universal Terrestrial Radio Access (E-UTRA)) and NR, dual connectivity (NR-E-UTRA Dual Connectivity (NE-DC)) between NR and LTE, and so on.

In EN-DC, a base station (eNB) of LTE (E-UTRA) is a master node (MN), and a base station (gNB) of NR is a secondary node (SN). In NE-DC, a base station (gNB) of NR is an MN, and a base station (eNB) of LTE (E-UTRA) is an SN.

The radio communication system 1 may support dual connectivity between a plurality of base stations in the same RAT (for example, dual connectivity (NR-NR Dual Connectivity (NN-DC)) where both of an MN and an SN are base stations (gNB) of NR).

The radio communication system 1 may include a base station 11 that forms a macro cell C1 of a relatively wide coverage, and base stations 12 (12a to 12c) that form small cells C2, which are placed within the macro cell C1 and which are narrower than the macro cell C1. The user terminal 20 may be located in at least one cell. The arrangement, the number, and the like of each cell and user terminal 20 are by no means limited to the aspect shown in the diagram. Hereinafter, the base stations 11 and 12 will be collectively referred to as “base stations 10,” unless specified otherwise.

The user terminal 20 may be connected to at least one of the plurality of base stations 10. The user terminal 20 may use at least one of carrier aggregation (CA) and dual connectivity (DC) using a plurality of component carriers (CCs).

Each CC may be included in at least one of a first frequency band (Frequency Range 1 (FR1)) and a second frequency band (Frequency Range 2 (FR2)). The macro cell C1 may be included in FR1, and the small cells C2 may be included in FR2. For example, FR1 may be a frequency band of 6 GHz or less (sub-6 GHz), and FR2 may be a frequency band which is higher than 24 GHz (above-24 GHz). Note that frequency bands, definitions and so on of FR1 and FR2 are by no means limited to these, and for example, FR1 may correspond to a frequency band which is higher than FR2.

The user terminal 20 may communicate using at least one of time division duplex (TDD) and frequency division duplex (FDD) in each CC.

The plurality of base stations 10 may be connected by a wired connection (for example, optical fiber in compliance with the Common Public Radio Interface (CPRI), the X2 interface and so on) or a wireless connection (for example, an NR communication). For example, if an NR communication is used as a backhaul between the base stations 11 and 12, the base station 11 corresponding to a higher station may be referred to as an “Integrated Access Backhaul (IAB) donor,” and the base station 12 corresponding to a relay station (relay) may be referred to as an “IAB node.”

The base station 10 may be connected to a core network 30 through another base station 10 or directly. For example, the core network 30 may include at least one of Evolved Packet Core (EPC), 5G Core Network (SGCN), Next Generation Core (NGC), and so on.

The user terminal 20 may be a terminal supporting at least one of communication schemes such as LTE, LTE-A, 5G, and so on.

In the radio communication system 1, an orthogonal frequency division multiplexing (OFDM)-based wireless access scheme may be used. For example, in at least one of the downlink (DL) and the uplink (UL), Cyclic Prefix OFDM (CP-OFDM), Discrete Fourier Transform Spread OFDM (DFT-s-OFDM), Orthogonal Frequency Division Multiple Access (OFDMA), Single Carrier Frequency Division Multiple Access (SC-FDMA), and so on may be used.

The wireless access scheme may be referred to as a “waveform.” Note that, in the radio communication system 1, another wireless access scheme (for example, another single carrier transmission scheme, another multi-carrier transmission scheme) may be used for a wireless access scheme in the UL and the DL.

In the radio communication system 1, a downlink shared channel (Physical Downlink Shared Channel (PDSCH)), which is used by each user terminal 20 on a shared basis, a broadcast channel (Physical Broadcast Channel (PBCH)), a downlink control channel (Physical Downlink Control Channel (PDCCH)) and so on, may be used as downlink channels.

In the radio communication system 1, an uplink shared channel (Physical Uplink Shared Channel (PUSCH)), which is used by each user terminal 20 on a shared basis, an uplink control channel (Physical Uplink Control Channel (PUCCH)), a random access channel (Physical Random Access Channel (PRACH)) and so on may be used as uplink channels.

User data, higher layer control information, System Information Blocks (SIBs) and so on are communicated on the PDSCH. User data, higher layer control information and so on may be communicated on the PUSCH. The Master Information Blocks (MIBs) may be communicated on the PBCH.

Lower layer control information may be communicated on the PDCCH. For example, the lower layer control information may include downlink control information (DCI) including scheduling information of at least one of the PDSCH and the PUSCH.

Note that DCI for scheduling the PDSCH may be referred to as “DL assignment,” “DL DCI,” and so on, and DCI for scheduling the PUSCH may be referred to as “UL grant,” “UL DCI,” and so on. Note that the PDSCH may be interpreted as “DL data”, and the PUSCH may be interpreted as “UL data”.

For detection of the PDCCH, a control resource set (CORESET) and a search space may be used. The CORESET corresponds to a resource to search DCI. The search space corresponds to a search area and a search method of PDCCH candidates. One CORESET may be associated with one or more search spaces. The UE may monitor a CORESET associated with a certain search space, based on search space configuration.

One search space may correspond to a PDCCH candidate corresponding to one or more aggregation levels. One or more search spaces may be referred to as a “search space set.” Note that a “search space,” a “search space set,” a “search space configuration,” a “search space set configuration,” a “CORESET,” a “CORESET configuration” and so on of the present disclosure may be interchangeably interpreted.

Uplink control information (UCI) including at least one of channel state information (CSI), transmission confirmation information (for example, which may be also referred to as Hybrid Automatic Repeat reQuest ACKnowledgement (HARQ-ACK), ACK/NACK, and so on), and scheduling request (SR) may be communicated by means of the PUCCH. By means of the PRACH, random access preambles for establishing connections with cells may be communicated.

Note that the downlink, the uplink, and so on in the present disclosure may be expressed without a term of “link.” In addition, various channels may be expressed without adding “Physical” to the head.

In the radio communication system 1, a synchronization signal (SS), a downlink reference signal (DL-RS), and so on may be communicated. In the radio communication system 1, a cell-specific reference signal (CRS), a channel state information-reference signal (CSI-RS), a demodulation reference signal (DMRS), a positioning reference signal (PRS), a phase tracking reference signal (PTRS), and so on may be communicated as the DL-RS.

For example, the synchronization signal may be at least one of a primary synchronization signal (PSS) and a secondary synchronization signal (SSS). A signal block including an SS (PSS, SSS) and a PBCH (and a DMRS for a PBCH) may be referred to as an “SS/PBCH block,” an “SS Block (SSB),” and so on. Note that an SS, an SSB, and so on may be also referred to as a “reference signal.”

In the radio communication system 1, a sounding reference signal (SRS), a demodulation reference signal (DMRS), and so on may be communicated as an uplink reference signal (UL-RS). Note that DMRS may be referred to as a “user terminal specific reference signal (UE-specific Reference Signal).”

### (Base Station)

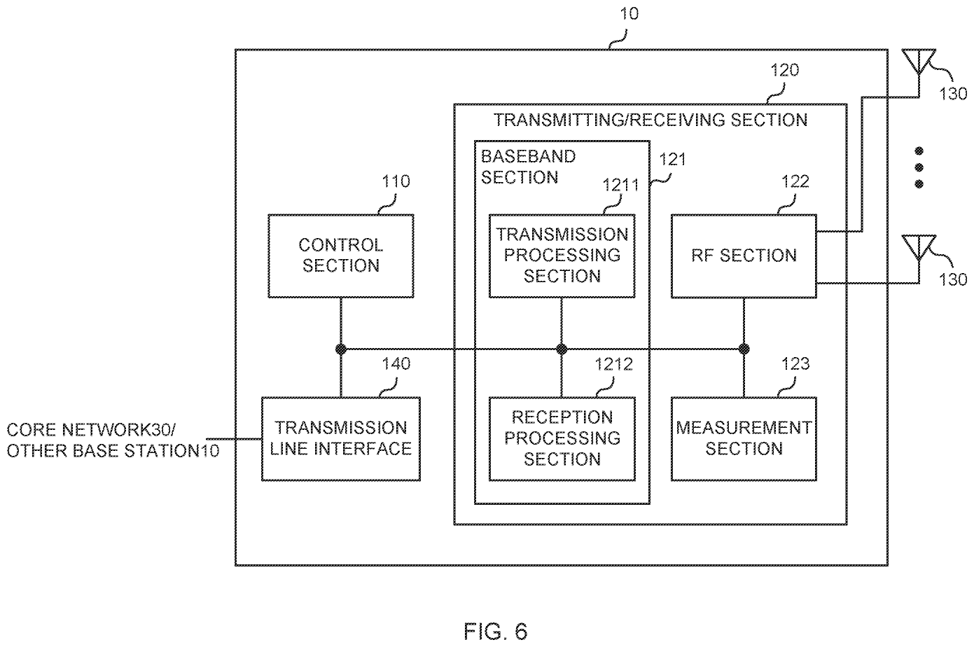

FIG. 6 is a diagram to show an example of a structure of the base station according to one embodiment. The base station 10 includes a control section 110, a transmitting/receiving section 120, transmitting/receiving antennas 130 and a communication path interface (transmission line interface) 140. Note that the base station 10 may include one or more control sections 110, one or more transmitting/receiving sections 120, one or more transmitting/receiving antennas 130, and one or more communication path interfaces 140.

Note that, the present example primarily shows functional blocks that pertain to characteristic parts of the present embodiment, and it is assumed that the base station 10 may include other functional blocks that are necessary for radio communication as well. Part of the processes of each section described below may be omitted.

The control section 110 controls the whole of the base station 10. The control section 110 can be constituted with a controller, a control circuit, or the like described based on general understanding of the technical field to which the present disclosure pertains.

The control section 110 may control generation of signals, scheduling (for example, resource allocation, mapping), and so on. The control section 110 may control transmission and reception, measurement and so on using the transmitting/receiving section 120, the transmitting/receiving antennas 130, and the communication path interface 140. The control section 110 may generate data, control information, a sequence and so on to transmit as a signal, and forward the generated items to the transmitting/receiving section 120. The control section 110 may perform call processing (setting up, releasing) for communication channels, manage the state of the base station 10, and manage the radio resources.

The transmitting/receiving section 120 may include a baseband section 121, a Radio Frequency (RF) section 122, and a measurement section 123. The baseband section 121 may include a transmission processing section 1211 and a reception processing section 1212. The transmitting/receiving section 120 can be constituted with a transmitter/receiver, an RF circuit, a baseband circuit, a filter, a phase shifter, a measurement circuit, a transmitting/receiving circuit, or the like described based on general understanding of the technical field to which the present disclosure pertains.

The transmitting/receiving section 120 may be structured as a transmitting/receiving section in one entity, or may be constituted with a transmitting section and a receiving section. The transmitting section may be constituted with the transmission processing section 1211, and the RF section 122. The receiving section may be constituted with the reception processing section 1212, the RF section 122, and the measurement section 123.

The transmitting/receiving antennas 130 can be constituted with antennas, for example, an array antenna, or the like described based on general understanding of the technical field to which the present disclosure pertains.

The transmitting/receiving section 120 may transmit the above-described downlink channel, synchronization signal, downlink reference signal, and so on. The transmitting/receiving section 120 may receive the above-described uplink channel, uplink reference signal, and so on.

The transmitting/receiving section 120 may form at least one of a transmit beam and a receive beam by using digital beam forming (for example, precoding), analog beam forming (for example, phase rotation), and so on.

The transmitting/receiving section 120 (transmission processing section 1211) may perform the processing of the Packet Data Convergence Protocol (PDCP) layer, the processing of the Radio Link Control (RLC) layer (for example, RLC retransmission control), the processing of the Medium Access Control (MAC) layer (for example, HARQ retransmission control), and so on, for example, on data and control information and so on acquired from the control section 110, and may generate bit string to transmit.

The transmitting/receiving section 120 (transmission processing section 1211) may perform transmission processing such as channel coding (which may include error correction coding), modulation, mapping, filtering, discrete Fourier transform (DFT) processing (as necessary), inverse fast Fourier transform (IFFT) processing, precoding, digital-to-analog conversion, and so on, on the bit string to transmit, and output a baseband signal.

The transmitting/receiving section 120 (RF section 122) may perform modulation to a radio frequency band, filtering, amplification, and so on, on the baseband signal, and transmit the signal of the radio frequency band through the transmitting/receiving antennas 130.

On the other hand, the transmitting/receiving section 120 (RF section 122) may perform amplification, filtering, demodulation to a baseband signal, and so on, on the signal of the radio frequency band received by the transmitting/receiving antennas 130.

The transmitting/receiving section 120 (reception processing section 1212) may apply reception processing such as analog-digital conversion, fast Fourier transform (FFT) processing, inverse discrete Fourier transform (IDFT) processing (as necessary), filtering, de-mapping, demodulation, decoding (which may include error correction decoding), MAC layer processing, the processing of the RLC layer and the processing of the PDCP layer, and so on, on the acquired baseband signal, and acquire user data, and so on.

The transmitting/receiving section 120 (measurement section 123) may perform the measurement related to the received signal. For example, the measurement section 123 may perform Radio Resource Management (RRM) measurement, Channel State Information (CSI) measurement, and so on, based on the received signal. The measurement section 123 may measure a received power (for example, Reference Signal Received Power (RSRP)), a received quality (for example, Reference Signal Received Quality (RSRQ), a Signal to Interference plus Noise Ratio (SINR), a Signal to Noise Ratio (SNR)), a signal strength (for example, Received Signal Strength Indicator (RSSI)), channel information (for example, CSI), and so on. The measurement results may be output to the control section 110.

The communication path interface 140 may perform transmission/reception (backhaul signaling) of a signal with an apparatus included in the core network 30 or other base stations and so on, and acquire or transmit user data (user plane data), control plane data, and so on for the user terminal 20.

Note that the transmitting section and the receiving section of the base station 10 in the present disclosure may be constituted with at least one of the transmitting/receiving section 120, the transmitting/receiving antennas 130, and the communication path interface 140.

Note that the transmitting/receiving section 120 may transmit a higher layer parameter corresponding to a report related to maximum permitted exposure (MPE) specific to a beam, and receive the report using a medium access control (MAC) control element (CE), the report being transmitted based on the higher layer parameter.

The control section 110 may control reception of the report using the medium access control (MAC) control element (CE), the report being transmitted based on the higher layer parameter.

### (User Terminal)

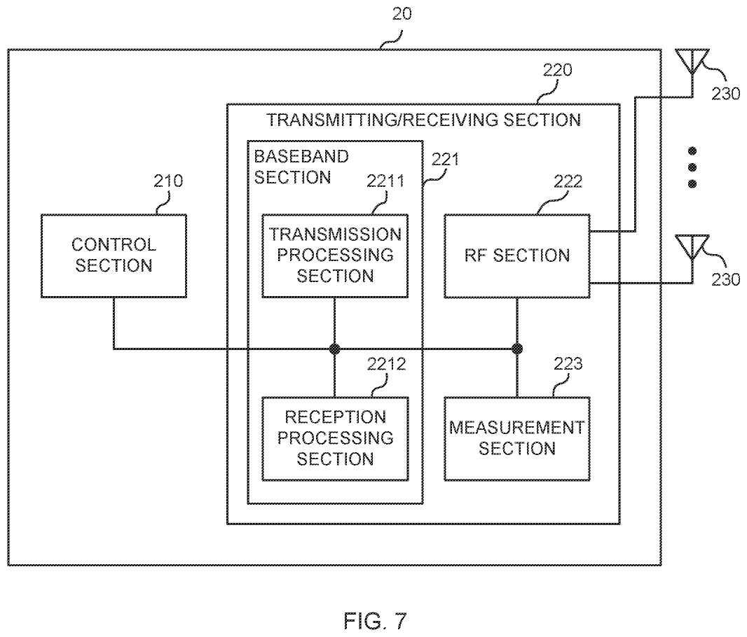

FIG. 7 is a diagram to show an example of a structure of the user terminal according to one embodiment. The user terminal 20 includes a control section 210, a transmitting/receiving section 220, and transmitting/receiving antennas 230. Note that the user terminal 20 may include one or more control sections 210, one or more transmitting/receiving sections 220, and one or more transmitting/receiving antennas 230.

Note that, the present example primarily shows functional blocks that pertain to characteristic parts of the present embodiment, and it is assumed that the user terminal 20 may include other functional blocks that are necessary for radio communication as well. Part of the processes of each section described below may be omitted.

The control section 210 controls the whole of the user terminal 20. The control section 210 can be constituted with a controller, a control circuit, or the like described based on general understanding of the technical field to which the present disclosure pertains.

The control section 210 may control generation of signals, mapping, and so on. The control section 210 may control transmission/reception, measurement and so on using the transmitting/receiving section 220, and the transmitting/receiving antennas 230. The control section 210 generates data, control information, a sequence and so on to transmit as a signal, and may forward the generated items to the transmitting/receiving section 220.

The transmitting/receiving section 220 may include a baseband section 221, an RF section 222, and a measurement section 223. The baseband section 221 may include a transmission processing section 2211 and a reception processing section 2212. The transmitting/receiving section 220 can be constituted with a transmitter/receiver, an RF circuit, a baseband circuit, a filter, a phase shifter, a measurement circuit, a transmitting/receiving circuit, or the like described based on general understanding of the technical field to which the present disclosure pertains.

The transmitting/receiving section 220 may be structured as a transmitting/receiving section in one entity, or may be constituted with a transmitting section and a receiving section. The transmitting section may be constituted with the transmission processing section 2211, and the RF section 222. The receiving section may be constituted with the reception processing section 2212, the RF section 222, and the measurement section 223.

The transmitting/receiving antennas 230 can be constituted with antennas, for example, an array antenna, or the like described based on general understanding of the technical field to which the present disclosure pertains.

The transmitting/receiving section 220 may receive the above-described downlink channel, synchronization signal, downlink reference signal, and so on. The transmitting/receiving section 220 may transmit the above-described uplink channel, uplink reference signal, and so on.

The transmitting/receiving section 220 may form at least one of a transmit beam and a receive beam by using digital beam forming (for example, precoding), analog beam forming (for example, phase rotation), and so on.

The transmitting/receiving section 220 (transmission processing section 2211) may perform the processing of the PDCP layer, the processing of the RLC layer (for example, RLC retransmission control), the processing of the MAC layer (for example, HARQ retransmission control), and so on, for example, on data and control information and so on acquired from the control section 210, and may generate bit string to transmit.

The transmitting/receiving section 220 (transmission processing section 2211) may perform transmission processing such as channel coding (which may include error correction coding), modulation, mapping, filtering, DFT processing (as necessary), IFFT processing, precoding, digital-to-analog conversion, and so on, on the bit string to transmit, and output a baseband signal.

Note that, whether to apply DFT processing or not may be based on the configuration of the transform precoding. The transmitting/receiving section 220 (transmission processing section 2211) may perform, for a certain channel (for example, PUSCH), the DFT processing as the above-described transmission processing to transmit the channel by using a DFT-s-OFDM waveform if transform precoding is enabled, and otherwise, does not need to perform the DFT processing as the above-described transmission process.

The transmitting/receiving section 220 (RF section 222) may perform modulation to a radio frequency band, filtering, amplification, and so on, on the baseband signal, and transmit the signal of the radio frequency band through the transmitting/receiving antennas 230.

On the other hand, the transmitting/receiving section 220 (RF section 222) may perform amplification, filtering, demodulation to a baseband signal, and so on, on the signal of the radio frequency band received by the transmitting/receiving antennas 230.

The transmitting/receiving section 220 (reception processing section 2212) may apply a receiving process such as analog-digital conversion, FFT processing, IDFT processing (as necessary), filtering, de-mapping, demodulation, decoding (which may include error correction decoding), MAC layer processing, the processing of the RLC layer and the processing of the PDCP layer, and so on, on the acquired baseband signal, and acquire user data, and so on.

The transmitting/receiving section 220 (measurement section 223) may perform the measurement related to the received signal. For example, the measurement section 223 may perform RRM measurement, CSI measurement, and so on, based on the received signal. The measurement section 223 may measure a received power (for example, RSRP), a received quality (for example, RSRQ, SINR, SNR), a signal strength (for example, RSSI), channel information (for example, CSI), and so on. The measurement results may be output to the control section 210.

Note that the transmitting section and the receiving section of the user terminal 20 in the present disclosure may be constituted with at least one of the transmitting/receiving section 220 and the transmitting/receiving antennas 230.

Note that the transmitting/receiving section 220 may receive a higher layer parameter corresponding to a report related to maximum permitted exposure (MPE) specific to a beam, and transmit the report by using a medium access control (MAC) control element (CE), based on the higher layer parameter.

The higher layer parameter may include at least one of a parameter indicating whether to transmit the report, a timer executed when the report is triggered, and a threshold corresponding to power management maximum power reduction for the beam. The higher layer parameter may be configured for each terminal, for each cell group, for each serving cell, or for each bandwidth part.

The control section 210 may control transmission of the report using the medium access control (MAC) control element (CE), based on the higher layer parameter. The control section 210 may control transmission of both of the report related to maximum permitted exposure (MPE) specific to the beam and the report related to maximum permitted exposure (MPE) specific to the terminal.

### (Hardware Structure)

Note that the block diagrams that have been used to describe the above embodiments show blocks in functional units. These functional blocks (components) may be implemented in arbitrary combinations of at least one of hardware and software. Also, the method for implementing each functional block is not particularly limited. That is, each functional block may be realized by one piece of apparatus that is physically or logically coupled, or may be realized by directly or indirectly connecting two or more physically or logically separate pieces of apparatus (for example, via wire, wireless, or the like) and using these plurality of pieces of apparatus. The functional blocks may be implemented by combining softwares into the apparatus described above or the plurality of apparatuses described above.

Here, functions include judgment, determination, decision, calculation, computation, processing, derivation, investigation, search, confirmation, reception, transmission, output, access, resolution, selection, designation, establishment, comparison, assumption, expectation, considering, broadcasting, notifying, communicating, forwarding, configuring, reconfiguring, allocating (mapping), assigning, and the like, but function are by no means limited to these. For example, functional block (components) to implement a function of transmission may be referred to as a “transmitting section (transmitting unit),” a “transmitter,” and the like. The method for implementing each component is not particularly limited as described above.

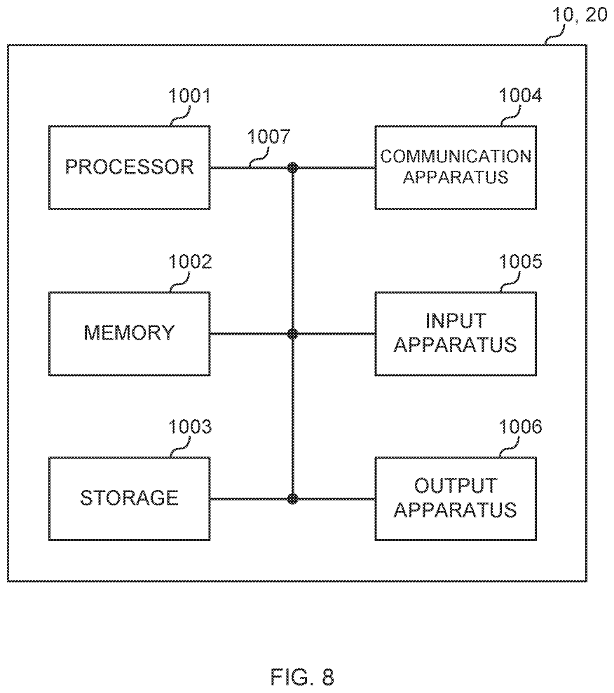

For example, a base station, a user terminal, and so on according to one embodiment of the present disclosure may function as a computer that executes the processes of the radio communication method of the present disclosure. FIG. 8 is a diagram to show an example of a hardware structure of the base station and the user terminal according to one embodiment. Physically, the above-described base station 10 and user terminal 20 may each be formed as a computer apparatus that includes a processor 1001, a memory 1002, a storage 1003, a communication apparatus 1004, an input apparatus 1005, an output apparatus 1006, a bus 1007, and so on.

Note that in the present disclosure, the words such as an apparatus, a circuit, a device, a section, a unit, and so on can be interchangeably interpreted. The hardware structure of the base station 10 and the user terminal 20 may be configured to include one or more of apparatuses shown in the drawings, or may be configured not to include part of apparatuses.

For example, although only one processor 1001 is shown, a plurality of processors may be provided. Furthermore, processes may be implemented with one processor or may be implemented at the same time, in sequence, or in different manners with two or more processors. Note that the processor 1001 may be implemented with one or more chips.

Each function of the base station 10 and the user terminals 20 is implemented, for example, by allowing certain software (programs) to be read on hardware such as the processor 1001 and the memory 1002, and by allowing the processor 1001 to perform calculations to control communication via the communication apparatus 1004 and control at least one of reading and writing of data in the memory 1002 and the storage 1003.

The processor 1001 controls the whole computer by, for example, running an operating system. The processor 1001 may be configured with a central processing unit (CPU), which includes interfaces with peripheral apparatus, control apparatus, computing apparatus, a register, and so on. For example, at least part of the above-described control section 110 (210), the transmitting/receiving section 120 (220), and so on may be implemented by the processor 1001.

Furthermore, the processor 1001 reads programs (program codes), software modules, data, and so on from at least one of the storage 1003 and the communication apparatus 1004, into the memory 1002, and executes various processes according to these. As for the programs, programs to allow computers to execute at least part of the operations of the above-described embodiments are used. For example, the control section 110 (210) may be implemented by control programs that are stored in the memory 1002 and that operate on the processor 1001, and other functional blocks may be implemented likewise.

The memory 1002 is a computer-readable recording medium, and may be constituted with, for example, at least one of a Read Only Memory (ROM), an Erasable Programmable ROM (EPROM), an Electrically EPROM (EEPROM), a Random Access Memory (RAM), and other appropriate storage media. The memory 1002 may be referred to as a “register,” a “cache,” a “main memory (primary storage apparatus)” and so on. The memory 1002 can store executable programs (program codes), software modules, and the like for implementing the radio communication method according to one embodiment of the present disclosure.

The storage 1003 is a computer-readable recording medium, and may be constituted with, for example, at least one of a flexible disk, a floppy (registered trademark) disk, a magneto-optical disk (for example, a compact disc (Compact Disc ROM (CD-ROM) and so on), a digital versatile disc, a Blu-ray (registered trademark) disk), a removable disk, a hard disk drive, a smart card, a flash memory device (for example, a card, a stick, and a key drive), a magnetic stripe, a database, a server, and other appropriate storage media. The storage 1003 may be referred to as “secondary storage apparatus.”

The communication apparatus 1004 is hardware (transmitting/receiving device) for allowing inter-computer communication via at least one of wired and wireless networks, and may be referred to as, for example, a “network device,” a “network controller,” a “network card,” a “communication module,” and so on. The communication apparatus 1004 may be configured to include a high frequency switch, a duplexer, a filter, a frequency synthesizer, and so on in order to realize, for example, at least one of frequency division duplex (FDD) and time division duplex (TDD). For example, the above-described transmitting/receiving section 120 (220), the transmitting/receiving antennas 130 (230), and so on may be implemented by the communication apparatus 1004. In the transmitting/receiving section 120 (220), the transmitting section 120a (220a) and the receiving section 120b (220b) can be implemented while being separated physically or logically.

The input apparatus 1005 is an input device that receives input from the outside (for example, a keyboard, a mouse, a microphone, a switch, a button, a sensor, and so on). The output apparatus 1006 is an output device that allows sending output to the outside (for example, a display, a speaker, a Light Emitting Diode (LED) lamp, and so on). Note that the input apparatus 1005 and the output apparatus 1006 may be provided in an integrated structure (for example, a touch panel).

Furthermore, these types of apparatus, including the processor 1001, the memory 1002, and others, are connected by a bus 1007 for communicating information. The bus 1007 may be formed with a single bus, or may be formed with buses that vary between pieces of apparatus.

Also, the base station 10 and the user terminals 20 may be structured to include hardware such as a microprocessor, a digital signal processor (DSP), an Application Specific Integrated Circuit (ASIC), a Programmable Logic Device (PLD), a Field Programmable Gate Array (FPGA), and so on, and part or all of the functional blocks may be implemented by the hardware. For example, the processor 1001 may be implemented with at least one of these pieces of hardware.

### (Variations)

Note that the terminology described in the present disclosure and the terminology that is needed to understand the present disclosure may be replaced by other terms that convey the same or similar meanings. For example, a “channel,” a “symbol,” and a “signal” (or signaling) may be interchangeably interpreted. Also, “signals” may be “messages.” A reference signal may be abbreviated as an “RS,” and may be referred to as a “pilot,” a “pilot signal,” and so on, depending on which standard applies. Furthermore, a “component carrier (CC)” may be referred to as a “cell,” a “frequency carrier,” a “carrier frequency” and so on.

A radio frame may be constituted of one or a plurality of periods (frames) in the time domain. Each of one or a plurality of periods (frames) constituting a radio frame may be referred to as a “subframe.” Furthermore, a subframe may be constituted of one or a plurality of slots in the time domain. A subframe may be a fixed time length (for example, 1 ms) independent of numerology.

Here, numerology may be a communication parameter applied to at least one of transmission and reception of a certain signal or channel. For example, numerology may indicate at least one of a subcarrier spacing (SCS), a bandwidth, a symbol length, a cyclic prefix length, a transmission time interval (TTI), the number of symbols per TTI, a radio frame structure, a particular filter processing performed by a transceiver in the frequency domain, a particular windowing processing performed by a transceiver in the time domain, and so on.

A slot may be constituted of one or a plurality of symbols in the time domain (Orthogonal Frequency Division Multiplexing (OFDM) symbols, Single Carrier Frequency Division Multiple Access (SC-FDMA) symbols, and so on). Furthermore, a slot may be a time unit based on numerology.

A slot may include a plurality of mini-slots. Each mini-slot may be constituted of one or a plurality of symbols in the time domain. A mini-slot may be referred to as a “sub-slot.” A mini-slot may be constituted of symbols less than the number of slots. A PDSCH (or PUSCH) transmitted in a time unit larger than a mini-slot may be referred to as “PDSCH (PUSCH) mapping type A.” A PDSCH (or PUSCH) transmitted using a mini-slot may be referred to as “PDSCH (PUSCH) mapping type B.”

A radio frame, a subframe, a slot, a mini-slot, and a symbol all express time units in signal communication. A radio frame, a subframe, a slot, a mini-slot, and a symbol may each be called by other applicable terms. Note that time units such as a frame, a subframe, a slot, mini-slot, and a symbol in the present disclosure may be interchangeably interpreted.

For example, one subframe may be referred to as a “TTI,” a plurality of consecutive subframes may be referred to as a “TTI,” or one slot or one mini-slot may be referred to as a “TTI.” That is, at least one of a subframe and a TTI may be a subframe (1 ms) in existing LTE, may be a shorter period than 1 ms (for example, 1 to 13 symbols), or may be a longer period than 1 ms. Note that a unit expressing TTI may be referred to as a “slot,” a “mini-slot,” and so on instead of a “subframe.”

Here, a TTI refers to the minimum time unit of scheduling in radio communication, for example. For example, in LTE systems, a base station schedules the allocation of radio resources (such as a frequency bandwidth and transmit power that are available for each user terminal) for the user terminal in TTI units. Note that the definition of TTIs is not limited to this.

TTIs may be transmission time units for channel-encoded data packets (transport blocks), code blocks, or codewords, or may be the unit of processing in scheduling, link adaptation, and so on. Note that, when TTIs are given, the time interval (for example, the number of symbols) to which transport blocks, code blocks, codewords, or the like are actually mapped may be shorter than the TTIs.

Note that, in the case where one slot or one mini-slot is referred to as a TTI, one or more TTIs (that is, one or more slots or one or more mini-slots) may be the minimum time unit of scheduling. Furthermore, the number of slots (the number of mini-slots) constituting the minimum time unit of the scheduling may be controlled.

A TTI having a time length of 1 ms may be referred to as a “normal TTI” (TTI in 3GPP Rel. 8 to Rel. 12), a “long TTI,” a “normal subframe,” a “long subframe,” a “slot” and so on. A TTI that is shorter than a normal TTI may be referred to as a “shortened TTI,” a “short TTI,” a “partial or fractional TTI,” a “shortened subframe,” a “short subframe,” a “mini-slot,” a “sub-slot,” a “slot” and so on.

Note that a long TTI (for example, a normal TTI, a subframe, and so on) may be interpreted as a TTI having a time length exceeding 1 ms, and a short TTI (for example, a shortened TTI and so on) may be interpreted as a TTI having a TTI length shorter than the TTI length of a long TTI and equal to or longer than 1 ms.

A resource block (RB) is the unit of resource allocation in the time domain and the frequency domain, and may include one or a plurality of consecutive subcarriers in the frequency domain. The number of subcarriers included in an RB may be the same regardless of numerology, and, for example, may be 12. The number of subcarriers included in an RB may be determined based on numerology.

Also, an RB may include one or a plurality of symbols in the time domain, and may be one slot, one mini-slot, one subframe, or one TTI in length. One TTI, one subframe, and so on each may be constituted of one or a plurality of resource blocks.

Note that one or a plurality of RBs may be referred to as a “physical resource block (Physical RB (PRB)),” a “sub-carrier group (SCG),” a “resource element group (REG),” a “PRB pair,” an “RB pair” and so on.

Furthermore, a resource block may be constituted of one or a plurality of resource elements (REs). For example, one RE may correspond to a radio resource field of one subcarrier and one symbol.

A bandwidth part (BWP) (which may be referred to as a “fractional bandwidth,” and so on) may represent a subset of contiguous common resource blocks (common RBs) for certain numerology in a certain carrier. Here, a common RB may be specified by an index of the RB based on the common reference point of the carrier. A PRB may be defined by a certain BWP and may be numbered in the BWP.

The BWP may include a UL BWP (BWP for the UL) and a DL BWP (BWP for the DL). One or a plurality of BWPs may be configured in one carrier for a UE.

At least one of configured BWPs may be active, and a UE does not need to assume to transmit/receive a certain signal/channel outside active BWPs. Note that a “cell,” a “carrier,” and so on in the present disclosure may be interpreted as a “BWP”.

Note that the above-described structures of radio frames, subframes, slots, mini-slots, symbols, and so on are merely examples. For example, structures such as the number of subframes included in a radio frame, the number of slots per subframe or radio frame, the number of mini-slots included in a slot, the numbers of symbols and RBs included in a slot or a mini-slot, the number of subcarriers included in an RB, the number of symbols in a TTI, the symbol length, the cyclic prefix (CP) length, and so on can be variously changed.

Also, the information, parameters, and so on described in the present disclosure may be represented in absolute values or in relative values with respect to certain values, or may be represented in another corresponding information. For example, radio resources may be specified by certain indices.

The names used for parameters and so on in the present disclosure are in no respect limiting. Furthermore, mathematical expressions that use these parameters, and so on may be different from those expressly disclosed in the present disclosure. For example, since various channels (PUCCH, PDCCH, and so on) and information elements can be identified by any suitable names, the various names allocated to these various channels and information elements are in no respect limiting.

The information, signals, and so on described in the present disclosure may be represented by using any of a variety of different technologies. For example, data, instructions, commands, information, signals, bits, symbols, chips, and so on, all of which may be referenced throughout the herein-contained description, may be represented by voltages, currents, electromagnetic waves, magnetic fields or particles, optical fields or photons, or any combination of these.

Also, information, signals, and so on can be output in at least one of from higher layers to lower layers and from lower layers to higher layers. Information, signals, and so on may be input and/or output via a plurality of network nodes.

The information, signals, and so on that are input and/or output may be stored in a specific location (for example, a memory) or may be managed by using a management table. The information, signals, and so on to be input and/or output can be overwritten, updated, or appended. The information, signals, and so on that are output may be deleted. The information, signals, and so on that are input may be transmitted to another apparatus.

Reporting of information is by no means limited to the aspects/embodiments described in the present disclosure, and other methods may be used as well. For example, reporting of information in the present disclosure may be implemented by using physical layer signaling (for example, downlink control information (DCI), uplink control information (UCI), higher layer signaling (for example, Radio Resource Control (RRC) signaling, broadcast information (master information block (MIB), system information blocks (SIBs), and so on), Medium Access Control (MAC) signaling and so on), and other signals or combinations of these.

Note that physical layer signaling may be referred to as “Layer 1/Layer 2 (L1/L2) control information (L1/L2 control signals),” “L1 control information (L1 control signal),” and so on. Also, RRC signaling may be referred to as an “RRC message,” and can be, for example, an RRC connection setup message, an RRC connection reconfiguration message, and so on. Also, MAC signaling may be reported using, for example, MAC control elements (MAC CEs).

Also, reporting of certain information (for example, reporting of “X holds”) does not necessarily have to be reported explicitly, and can be reported implicitly (by, for example, not reporting this certain information or reporting another piece of information).

Determinations may be made in values represented by one bit (0 or 1), may be made in Boolean values that represent true or false, or may be made by comparing numerical values (for example, comparison against a certain value).

Software, whether referred to as “software,” “firmware,” “middleware,” “microcode,” or “hardware description language,” or called by other terms, should be interpreted broadly to mean instructions, instruction sets, code, code segments, program codes, programs, subprograms, software modules, applications, software applications, software packages, routines, subroutines, objects, executable files, execution threads, procedures, functions, and so on.

Also, software, commands, information, and so on may be transmitted and received via communication media. For example, when software is transmitted from a website, a server, or other remote sources by using at least one of wired technologies (coaxial cables, optical fiber cables, twisted-pair cables, digital subscriber lines (DSL), and so on) and wireless technologies (infrared radiation, microwaves, and so on), at least one of these wired technologies and wireless technologies are also included in the definition of communication media.

The terms “system” and “network” used in the present disclosure can be used interchangeably. The “network” may mean an apparatus (for example, a base station) included in the network.

In the present disclosure, the terms such as “precoding,” a “precoder,” a “weight (precoding weight),” “quasi-co-location (QCL),” a “Transmission Configuration Indication state (TCI state),” a “spatial relation,” a “spatial domain filter,” a “transmit power,” “phase rotation,” an “antenna port,” an “antenna port group,” a “layer,” “the number of layers,” a “rank,” a “resource,” a “resource set,” a “resource group,” a “beam,” a “beam width,” a “beam angular degree,” an “antenna,” an “antenna element,” a “panel,” and so on can be used interchangeably.

In the present disclosure, the terms such as a “base station (BS),” a “radio base station,” a “fixed station,” a “NodeB,” an “eNB (eNodeB),” a “gNB (gNodeB),” an “access point,” a “transmission point (TP),” a “reception point (RP),” a “transmission/reception point (TRP),” a “panel,” a “cell,” a “sector,” a “cell group,” a “carrier,” a “component carrier,” and so on can be used interchangeably. The base station may be referred to as the terms such as a “macro cell,” a small cell,” a “femto cell,” a “pico cell,” and so on.

A base station can accommodate one or a plurality of (for example, three) cells. When a base station accommodates a plurality of cells, the entire coverage area of the base station can be partitioned into multiple smaller areas, and each smaller area can provide communication services through base station subsystems (for example, indoor small base stations (Remote Radio Heads (RRHs))). The term “cell” or “sector” refers to part of or the entire coverage area of at least one of a base station and a base station subsystem that provides communication services within this coverage.

In the present disclosure, the terms “mobile station (MS),” “user terminal,” “user equipment (UE),” and “terminal” may be used interchangeably.

A mobile station may be referred to as a “subscriber station,” “mobile unit,” “subscriber unit,” “wireless unit,” “remote unit,” “mobile device,” “wireless device,” “wireless communication device,” “remote device,” “mobile subscriber station,” “access terminal,” “mobile terminal,” “wireless terminal,” “remote terminal,” “handset,” “user agent,” “mobile client,” “client,” or some other appropriate terms in some cases.

At least one of a base station and a mobile station may be referred to as a “transmitting apparatus,” a “receiving apparatus,” a “radio communication apparatus,” and so on. Note that at least one of a base station and a mobile station may be device mounted on a mobile body or a mobile body itself, and so on. The mobile body may be a vehicle (for example, a car, an airplane, and the like), may be a mobile body which moves unmanned (for example, a drone, an automatic operation car, and the like), or may be a robot (a manned type or unmanned type). Note that at least one of a base station and a mobile station also includes an apparatus which does not necessarily move during communication operation. For example, at least one of a base station and a mobile station may be an Internet of Things (IoT) device such as a sensor, and the like.

Furthermore, the base station in the present disclosure may be interpreted as a user terminal. For example, each aspect/embodiment of the present disclosure may be applied to the structure that replaces a communication between a base station and a user terminal with a communication between a plurality of user terminals (for example, which may be referred to as “Device-to-Device (D2D),” “Vehicle-to-Everything (V2X),” and the like). In this case, user terminals 20 may have the functions of the base stations 10 described above. The words such as “uplink” and “downlink” may be interpreted as the words corresponding to the terminal-to-terminal communication (for example, “sidelink”). For example, an uplink channel, a downlink channel and so on may be interpreted as a sidelink channel.

Likewise, the user terminal in the present disclosure may be interpreted as base station. In this case, the base station 10 may have the functions of the user terminal 20 described above.

Actions which have been described in the present disclosure to be performed by a base station may, in some cases, be performed by upper nodes. In a network including one or a plurality of network nodes with base stations, it is clear that various operations that are performed to communicate with terminals can be performed by base stations, one or more network nodes (for example, Mobility Management Entities (MMEs), Serving-Gateways (S-GWs), and so on may be possible, but these are not limiting) other than base stations, or combinations of these.

The aspects/embodiments illustrated in the present disclosure may be used individually or in combinations, which may be switched depending on the mode of implementation. The order of processes, sequences, flowcharts, and so on that have been used to describe the aspects/embodiments in the present disclosure may be re-ordered as long as inconsistencies do not arise. For example, although various methods have been illustrated in the present disclosure with various components of steps in exemplary orders, the specific orders that are illustrated herein are by no means limiting.

The aspects/embodiments illustrated in the present disclosure may be applied to Long Term Evolution (LTE), LTE-Advanced (LTE-A), LTE-Beyond (LTE-B), SUPER 3G, IMT-Advanced, 4th generation mobile communication system (4G), 5th generation mobile communication system (5G), 6th generation mobile communication system (6G), xth generation mobile communication system (xG) (xG (where x is, for example, an integer or a decimal)), Future Radio Access (FRA), New-Radio Access Technology (RAT), New Radio (NR), New radio access (NX), Future generation radio access (FX), Global System for Mobile communications (GSM (registered trademark)), CDMA 2000, Ultra Mobile Broadband (UMB), IEEE 802.11 (Wi-Fi (registered trademark)), IEEE 802.16 (WiMAX (registered trademark)), IEEE 802.20, Ultra-WideBand (UWB), Bluetooth (registered trademark), systems that use other adequate radio communication methods and next-generation systems that are enhanced based on these. A plurality of systems may be combined (for example, a combination of LTE or LTE-A and 5G, and the like) and applied.

The phrase “based on” (or “on the basis of”) as used in the present disclosure does not mean “based only on” (or “only on the basis of”), unless otherwise specified. In other words, the phrase “based on” (or “on the basis of”) means both “based only on” and “based at least on” (“only on the basis of” and “at least on the basis of”).

Reference to elements with designations such as “first,” “second,” and so on as used in the present disclosure does not generally limit the quantity or order of these elements. These designations may be used in the present disclosure only for convenience, as a method for distinguishing between two or more elements. Thus, reference to the first and second elements does not imply that only two elements may be employed, or that the first element must precede the second element in some way.

The term “judging (determining)” as in the present disclosure herein may encompass a wide variety of actions. For example, “judging (determining)” may be interpreted to mean making “judgments (determinations)” about judging, calculating, computing, processing, deriving, investigating, looking up, search and inquiry (for example, searching a table, a database, or some other data structures), ascertaining, and so on.

Furthermore, “judging (determining)” may be interpreted to mean making “judgments (determinations)” about receiving (for example, receiving information), transmitting (for example, transmitting information), input, output, accessing (for example, accessing data in a memory), and so on.

In addition, “judging (determining)” as used herein may be interpreted to mean making “judgments (determinations)” about resolving, selecting, choosing, establishing, comparing, and so on. In other words, “judging (determining)” may be interpreted to mean making “judgments (determinations)” about some action.

In addition, “judging (determining)” may be interpreted as “assuming,” “expecting,” “considering,” and the like.

“The maximum transmit power” according to the present disclosure may mean a maximum value of the transmit power, may mean the nominal maximum transmit power (the nominal UE maximum transmit power), or may mean the rated maximum transmit power (the rated UE maximum transmit power).

The terms “connected” and “coupled,” or any variation of these terms as used in the present disclosure mean all direct or indirect connections or coupling between two or more elements, and may include the presence of one or more intermediate elements between two elements that are “connected” or “coupled” to each other. The coupling or connection between the elements may be physical, logical, or a combination thereof. For example, “connection” may be interpreted as “access.”

In the present disclosure, when two elements are connected, the two elements may be considered “connected” or “coupled” to each other by using one or more electrical wires, cables and printed electrical connections, and, as some non-limiting and non-inclusive examples, by using electromagnetic energy having wavelengths in radio frequency regions, microwave regions, (both visible and invisible) optical regions, or the like.

In the present disclosure, the phrase “A and B are different” may mean that “A and B are different from each other.” Note that the phrase may mean that “A and B is each different from C.” The terms “separate,” “be coupled,” and so on may be interpreted similarly to “different.”

When terms such as “include,” “including,” and variations of these are used in the present disclosure, these terms are intended to be inclusive, in a manner similar to the way the term “comprising” is used. Furthermore, the term “or” as used in the present disclosure is intended to be not an exclusive disjunction.

For example, in the present disclosure, when an article such as “a,” “an,” and “the” in the English language is added by translation, the present disclosure may include that a noun after these articles is in a plural form.

Now, although the invention according to the present disclosure has been described in detail above, it should be obvious to a person skilled in the art that the invention according to the present disclosure is by no means limited to the embodiments described in the present disclosure. The invention according to the present disclosure can be implemented with various corrections and in various modifications, without departing from the spirit and scope of the invention defined by the recitations of claims. Consequently, the description of the present disclosure is provided only for the purpose of explaining examples, and should by no means be construed to limit the invention according to the present disclosure in any way.

1. A terminal comprising:
a receiving section that receives a higher layer parameter corresponding to a report related to maximum permitted exposure (MPE) specific to a beam; and
a control section that controls transmission of the report using a medium access control (MAC) control element (CE), based on the higher layer parameter.

2. The terminal according to claim 1, wherein
the higher layer parameter includes at least one of a parameter indicating whether to transmit the report, a timer executed when the report is triggered, and a threshold corresponding to power management maximum power reduction for the beam.

3. The terminal according to claim 1, wherein
the higher layer parameter is configured for each terminal, for each cell group, for each serving cell, or for each bandwidth part.

4. The terminal according to claim 1, wherein
the control section controls transmission of both of the report related to maximum permitted exposure (MPE) specific to the beam and the report related to maximum permitted exposure (MPE) specific to the terminal.

5. A radio communication method for a terminal, the radio communication method comprising:
receiving a higher layer parameter corresponding to a report related to maximum permitted exposure (MPE) specific to a beam; and
controlling transmission of the report using a medium access control (MAC) control element (CE), based on the higher layer parameter.

6. A base station comprising:
a transmitting section that transmits a higher layer parameter corresponding to a report related to maximum permitted exposure (MPE) specific to a beam; and
a control section that controls reception of the report using a medium access control (MAC) control element (CE), the report being transmitted based on the higher layer parameter.

7. The terminal according to claim 2, wherein
the higher layer parameter is configured for each terminal, for each cell group, for each serving cell, or for each bandwidth part.

8. The terminal according to claim 2, wherein
the control section controls transmission of both of the report related to maximum permitted exposure (MPE) specific to the beam and the report related to maximum permitted exposure (MPE) specific to the terminal.

9. The terminal according to claim 3, wherein
the control section controls transmission of both of the report related to maximum permitted exposure (MPE) specific to the beam and the report related to maximum permitted exposure (MPE) specific to the terminal.
